(19) United States
(12) Patent Application Publication
(10) Pub. No.: US 2025/0384666 A1
(43) Pub. Date: Dec. 18, 2025

(54) SELECTING IN-CONTEXT DEMONSTRATION EXAMPLES USING DIFFICULTY CLASSIFICATIONS

(71) Applicant: Google LLC, Mountain View, CA (US)

(72) Inventors: Arjun Reddy Akula, Sunnyvale, CA (US); Kazuma Hashimoto, Menlo Park, CA (US); Krishna P. Srinivasan, Union City, CA (US); Aditi Swanand Chaudhary, Mountain View, CA (US); Karthik Raman, San Jose, CA (US); Michael Bendersky, Cupertino, CA (US)

(21) Appl. No.: 19/242,884

(22) Filed: Jun. 18, 2025

Related U.S. Application Data
(60) Provisional application No. 63/661,536, filed on Jun. 18, 2024.

(51) Int. Cl. G06V 10/764; G06N 3/0475; G06V 20/70

(52) U.S. Cl. CPC G06V 10/764; G06N 3/0475; G06V 20/70

(57) ABSTRACT

Methods, systems, and apparatus, including computer programs encoded on a computer storage medium, for performing in-context learning using a generative neural network. In one aspect, a method comprises obtaining a plurality of demonstration examples for a task; obtaining a respective difficulty classification for each of the demonstration examples; generating a context input that includes one or more instances of at least a subset of the demonstration examples, the generating comprising, for each of the demonstration examples, determining how many instances of the demonstration example to include in the context input based on the respective difficulty classification for the demonstration example; receiving a new input for the task; and processing an input that includes the context input and the new input using the first generative neural network to generate a new output.

### CROSS-REFERENCE TO RELATED APPLICATION

This application claims priority to U.S. Provisional Application No. 63/661,536, filed on Jun. 18, 2024. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes systems and methods implemented as computer programs on one or more computers in one or more locations that can generate a context input for a particular task that can be provided to a generative neural network.

The context input is an input that is provided as input to the neural network along with a new input for the particular task. That is, when generating an output for the task for the new input, the generative neural network receives both the new input and the context input.

Including the context input can provide the generative neural network with information about how to perform the particular task and can improve the performance of the generative neural network on the particular task without further training of the generative neural network, e.g., through “in context learning.”

The subject matter described in this specification can be implemented in particular embodiments so as to realize one or more of the following advantages.

The emergence of long-context generative neural networks, e.g., large language models (LLMs) has enabled the use of hundreds, or even thousands, of demonstration examples for in-context learning (ICL)—a previously impractical regime. That is, the emergence of generative neural networks that have a “long context,” i.e., can accept as input very long input sequences, has allowed a large number of demonstration examples to be included as part of any given context input that is processed by the generative neural network.

However, traditional ICL selection strategies, which balance the similarity of ICL examples to the test input with diversity within the ICL set, may not be effective when utilizing a large number of demonstrations. In particular, while longer contexts can accommodate more examples, simply increasing the number of demonstrations does not guarantee improved performance. In particular, experiments have shown that the effectiveness of increasing the number of demonstrations that are included as part of the context input, i.e., in terms of improving the performance of the generative neural network on a given task, varies greatly depending on how the demonstrations are selected. Effectively selecting the demonstration examples therefore remains crucial, even with thousands of demonstrations.

To further enhance ICL in this setting, this specification describes techniques that are specifically designed to focus LLM attention on challenging (or “difficult”) demonstration examples. In particular, by strategically repeating difficult demonstration examples within the context input, the system allows the generative neural network to focus more strongly on these difficult examples when processing new (“test”) inputs. In some cases, this can be further enhancing by incorporating zero-shot predictions as error signals within the context input. As a result, the performance of long-context models can be significantly improved given a fixed number of demonstration examples.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example neural network system.

FIG. 2 is a flow diagram of an example process for generating a new output for a new input.

FIG. 3 is a flow diagram of an example process for determining difficulty classifications.

FIG. 4 illustrates an example of a context input.

Like reference numbers and designations in the various drawings indicate like elements.

### DETAILED DESCRIPTION

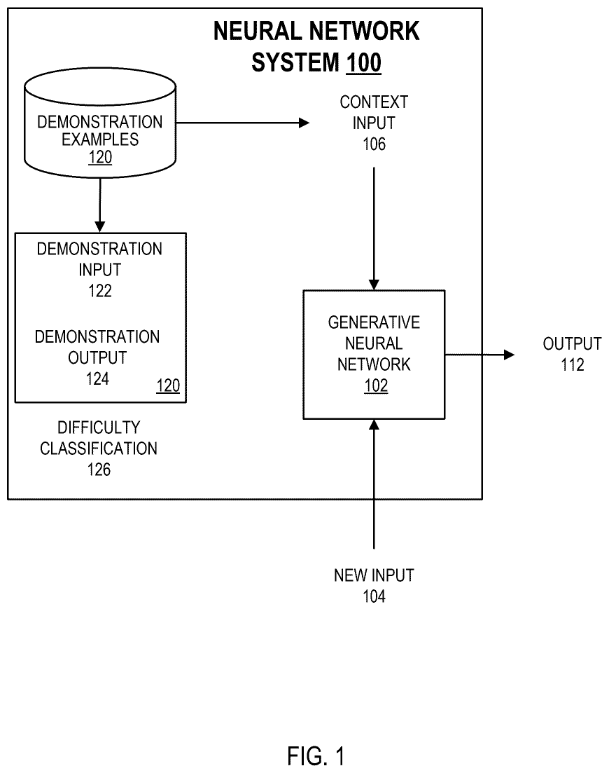

FIG. 1 shows an example neural network system 100. The neural network system 100 is an example of a system implemented as computer programs on one or more computers in one or more locations in which the systems, components, and techniques described below are implemented.

The system 100 can generate a context input 106 for a particular task (“machine learning task”) that can be provided to a generative neural network 102.

The context input 106 is an input that is provided as input to the neural network 102 along with a new input 104 for the particular task. That is, when generating an output 112 for the task for a new input 104, the generative neural network 102 receives both the new input 104 and the context input 106.

Including the context input 106 can provide the generative neural network 102 with information about how to perform the particular task and can improve the performance of the generative neural network 102 on the particular task without further training of the generative neural network 102, e.g., through “in context learning.”

The machine learning task can be any of a variety of tasks. For example, the machine learning task can include receiving an input query (e.g., an input prompt) from a user and processing the received query to generate an output as a response to the received query. The machine learning task can include, e.g., generating output text, an output image, output audio, an output video, and so on in response to a user query. As another example, the machine learning task can include selecting actions for an agent interacting with an environment to perform a task in the environment. As a further example, the machine learning task can include processing data characterizing the environment (e.g., data characterizing an observation of the environment) as a model input to generate a selected action for the agent as the model output. More generally, the output generated by the generative neural network 102 will be referred to as a “data item.” The data item can be of any appropriate modality, e.g., text, audio, video, image, or can be a multi-modal output that includes two or more different modalities.

The generative neural network 102 can have any appropriate architecture for processing input prompts (e.g., model inputs) for the machine learning task to generate output data items (e.g., model outputs) for the machine learning task. In particular, the generative neural network 102 can be a neural network that includes any of a variety of processing layers (e.g., feedforward layers, convolutional layers, recurrent layers, attention layers, graph processing layers, etc.) in any appropriate combination for performing the machine learning task.

For example, the generative neural network 102 can be a sequence processing neural network configured to generate output sequences (e.g., output token sequences) representing output data items for machine learning task by processing input sequences (e.g., input token sequences) representing input prompts for machine learning task. As a further example, the generative neural network 102 can be an auto-regressive generative neural network (e.g., a Transformer, a recurrent neural network, etc.) that can auto-regressively generate output sequences for the machine learning task. A transformer neural network is a neural network that includes a stack of transformer blocks, each typically including an attention or self-attention neural network layer, generally followed by a feedforward neural network layer (where a self-attention neural network layer applies a self-attention operation, e.g., QKV self-attention, to elements of an embedding, to update each element of the embedding).

The generative neural network 102 can, for example, be a large language model (LLM) that can generate tokenized representations of text data; a vision-language model (VLM) that can generate tokenized representations of image or video data, e.g., in response to a text input or that can generate tokenized representations of text, e.g., in response to an image input; an audio model that can input or generate tokenized representations of audio data; or a multimodal model that can that can generate output token sequences representing text data, image data or audio data, e.g., in response to inputs characterizing input text, input images input audio; and so on.

Generally, prior to the use of the generative neural network 102 by the system 100, the generative neural network 102 has already been trained across one or more previous training stages.

For example, the one or more previous training stages can include a pre-training stage. During the pre-training stage, the generative neural network 102 can have been trained by the system 100 or a separate system on a next token prediction task, e.g., a task that requires predicting, given a current sequence of tokens, the next token that follows the current sequence in the training data.

As a particular example, the generative neural network 102 can have been trained on a maximum-likelihood objective on a large dataset of text in one or more natural languages, e.g., text that is publicly available from the Internet or another text corpus, a large dataset of computer code in one or more programming languages, e.g., Python, C++, C#, Java, Ruby, PHP, and so on, e.g., computer code that is publicly available from the Internet or another code repository, a large dataset of audio samples, e.g., audio recordings or waveforms that represent the audio recordings, a large dataset of images where each image includes an array of pixels, a large dataset of videos where each video includes a temporal sequence of frames, or a large multi-modal dataset that includes a combination of two or more of these datasets.

As another example, the one or more previous training stages can include one or more additional training stages, e.g., that occur after the pre-training stage. For example, the one or more previous training stages can include any one or more of: a supervised fine-tuning stage, a reinforcement learning stage, a preference learning stage, an instruction tuning stage, and so on.

Example machine learning tasks and example architectures for the generative neural network 102 are described in more detail later in this specification.

Generally, the system 100 obtains a plurality of demonstration examples 120 for a task to be performed by the generative neural network 102. For example, as will be described in more detail below, the system 100 can obtain the demonstration examples 120 by searching a larger set of demonstration examples to identify the demonstration examples 120 that are most likely to be relevant to the new input 104.

The plurality of demonstration examples 120 each include a demonstration input 122 and a demonstration output 124. The demonstration input 122 is an example of an input for the task. The demonstration output 124 is an example of an output generated for the task by processing the demonstration input 122. For example, the demonstration output 124 can be a “target” or “ground truth” output for the demonstration input 122, i.e., the output that should be generated by performing the task on the input 122.

The system 100 also obtains a respective difficulty classification 126 for each of the demonstration examples 120 that classifies the demonstration example 120 as either a difficult example for the task or as not a difficult example for the task.

A demonstration example 120 is a “difficult example” when the generative neural network 102 is likely to generate an incorrect output, i.e., an output that is not equivalent to the demonstration output 124 in the example 120, by processing the demonstration input 122 in the demonstration example 120.

A demonstration example 120 is a “not difficult” example when the generative neural network 110 is not likely to generate an incorrect output by processing the demonstration input 122 in the demonstration example 120.

For example, difficulty classification 126 can be based on a “zero-shot” performance of the generative neural network 102 in terms of generating an output that matches the demonstration output 122 in the demonstration example 120 in a zero-shot fashion, i.e., when the input to the generative neural network 102 does not include any other demonstration examples.

In some cases, the difficulty classifications 126 are generated using the generative neural network 102 while in other cases, the difficulty classifications 126 are generated using a second, smaller generative neural network that serves to approximate the performance of the neural network 102.

The system 100 then generates a context input 106 that includes one or more instances of at least a subset of the demonstration examples 120.

As part of the generating, the system 106 determines how many instances of each demonstration example 120 to include in the context input 106 based on the respective difficulty classification 126 for the demonstration example 102.

Generally, the system 100 repeats, i.e., includes two or more instances of, difficult examples within the context input 106. This repetition diminishes or removes the inherent sequential bias of causal generative modeling, allowing challenging examples to comprehensively interact and inform each other when processed by the neural network 102. In other words, by highlighting and repeating difficult examples, the system 100 generates a context input 106 that significantly improves the performance of the neural network 102 on the particular task without requiring any further training.

The system 100 processes the new input 104 and the context input 106 using the generative neural network 102 to generate an output 112 for the new input.

As described above, in some cases, the system 100 obtains a respective set of demonstration examples 120 for each new input 104, i.e., can obtain a different sets of demonstration examples 120 for different new inputs 104. For example, the system can perform a similarity search, e.g., a Term Frequency-Inverse Document Frequency (TF-IDF) search or a search in an embedding space of a retrieval model, on a larger set of demonstration examples using the new input 104 to determine the set of demonstration examples. For example, the system can perform the search to identify a fixed number of demonstration examples that are most similar, according to TF-IDF or according to embedding similarity, between the new input 104 and the demonstration examples in a larger set of demonstration examples. The system 100 can measure the similarity between the new input 104 and a given demonstration example based on, e.g., the similarity between the new input 104 and the demonstration input in the demonstration example, the new input 104 and the demonstration output in the demonstration example, or the new input 104 and a combination of the demonstration input and demonstration output in the demonstration example. In some other cases, the system 100 uses the same set of demonstration examples (and the same context input 106) for each new input 104 that received for the task.

Example machine learning tasks and example architectures for the generative neural network 102 are described below.

In some implementations, the machine learning task can include processing an input prompt to generate an output data item. The input prompt and the output data item can include any of a variety of modalities of data, e.g., text data, image data, audio data, structured numerical data, and so on. In some implementations, the input prompt and/or the output data item can include multi-modal data, e.g., data for multiple different modalities. The quality scores for the output data items can characterize a quality or a perceived quality of the output data items. For example, the quality scores for the data items can characterize, e.g., perceptual scores for the data items, human feedback regarding the data items, and so on. As another example, the output data items can be used as part of performing a downstream task and the quality scores for the data items can be performance metrics for the downstream task as attained using the output data items.

In some implementations, the machine learning task can be a reinforcement learning task that involves controlling an agent to perform one or more agent tasks while interacting with an environment. In the context of reinforcement learning, the generative neural network 102 can be considered to be a policy for the agent, the prompts for the machine learning task can include observations of an environment of an agent and the output data items for the machine learning task can characterize actions for the agent to perform the agent's tasks. The quality scores for the output data items can be rewards associated with performance of the agent tasks by the agent.

As described above with reference to FIG. 1, the generative neural network 102 can be a language model or vision language model neural network. In general, a (vision) language model neural network can be a neural network that has been trained so that, given a text prompt that includes a sequence of tokens in a natural language, the neural network can generate the next token in the sequence. This process can be repeated to extend the text prompt one token at a time to generate a natural language output, i.e., to generate the natural language output auto-regressively token by token. At each time “time step,” the language model neural network processes the current sequence to generate a probability distribution over a vocabulary of tokens. The next token can then be selected using the probability distribution, e.g., by sampling from the distribution using nucleus sampling or another sampling technique or by selecting the highest-probability token. The tokens in the vocabulary can include any of a variety of tokens, e.g., some combination of words, sub-words, characters, punctuation and other symbols, and numbers. In general, the language model neural network is trained on a corpus of text made up of tokens from the vocabulary (and optionally other tokens that can be mapped to a designated out-of-vocabulary token), to predict the next token in a sequence of tokens from the training data. The (vision) language model neural network can be an autoregressive Transformer neural network.

A (vision) language model neural network can be made to perform a particular task by providing a natural language description of the desired response as an input or “prompt” (input sequence). In some cases, the prompt can be a few-shot prompt where a few, e.g., 1 to 10, examples of a query and an example output are provided in the text prior to the actual query.

A (vision) language model neural network can be “fine-tuned” to perform a particular task, by obtaining a pre-trained language model neural network trained on a large corpus of examples as previously described and then further training part of all of the language model neural network on a relatively small number of examples particular to the type of task that is to be performed.

The generative neural network 102 can be a large language model neural network, e.g., one that has greater than 1 billion, 10 billion or 100 billion trained parameters. The generative neural network 102 can have been trained on greater than 10 billion, 100 billion or 1000 billion words or tokens representing words or other tokens.

The model inputs and the model outputs can be sequences of elements referred to herein as tokens. A “token” as used in this specification is a vector of numerical values having a specified dimensionality, i.e., the number of numerical values is constant across different tokens. Each token can include a respective predetermined or learned embedding (an ordered collection of numerical values having a pre-determined dimensionality.

In some implementations, the model inputs and the model outputs can include tokens representing text, e.g., words, wordpieces or characters, in a natural or computer language. For example, text can be received, e.g., as a series of encoded characters, e.g., UTF-8 encoded characters; such “characters” can include Chinese and other similar characters, as well as logograms, syllabograms and the like. A text encoder, i.e., a tokenizer, can process a sequence of text to represent the text as a series of text tokens from a vocabulary of text tokens, e.g., that each represent words, wordpieces or characters in a natural or computer language. The computer language can be any formal language used to communicate with a computer, e.g., a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens can be converted into audio data that represent speech corresponding to the text.

In some implementations, the model inputs and the model outputs can include image tokens representing images. Each image token can include a block encoding of values of the pixels in a different region of an image that maps a set of values of the pixels to a respective image token. The block encoding can be obtained using a neural network such as a Transformer neural network.

As used herein an image can be any still or moving image, i.e., the image can be part of a video, in 2D or 3D, and can be a monochrome, color or hyperspectral image, i.e., including monochrome or color pixels. As defined herein an “image” includes a point cloud, e.g., from a LIDAR system, and a “pixel” includes a point of the point cloud. An image can be captured by a camera or other image sensor from the real world; and objects in the image can include physical objects, represented by the image.

In some implementations, the model inputs and the model outputs can include tokens representing audio waveforms. For example, a set (sequence) of input or output tokens can represent audio data representing a waveform e.g., instantaneous audio amplitude values or time-frequency audio data. Each audio token can include a block encoding of the audio waveform in a different time segment of the audio that maps a set of values representing the audio waveform to a respective image token. The block encoding can be obtained using a neural network such as a Transformer neural network.

In a multimodal system audio data or an image can be flagged by a start-of-audio token or start-of-image token.

In some implementations the model inputs can include tokens representing text, pixels of an image, or an audio waveform and the generative neural network 102 can generate the output sequence of tokens to perform tasks represented by the input sequence of tokens.

In some implementations the machine learning task can include an image or audio generation task. The input sequences of tokens can then characterize images or audio to be generated, and the output sequences of tokens can include tokens defining images or audio waveforms characterized by the input sequences of tokens, e.g., text tokens.

In some implementations the machine learning task can include an image or audio processing task. The input sequences of tokens can define image or audio inputs, and the output sequences of tokens can include tokens defining text that describes the image or audio inputs. As some examples, the machine learning task can include a speech recognition task, an object or action detection task, a classification task, a captioning task, a question-answering task, or a character or word recognition task.

In some implementations the machine learning task can include a multimodal processing task in which the input sequences of tokens and/or the output sequences of tokens can include multimodal data. For example, an input sequence of tokens can characterize both an image or audio input and a text input and a corresponding output sequence of tokens can include tokens defining a result of an image or audio processing task defined by the text, such as an open vocabulary classification or object detection task.

In general, multimodal data includes a combination of two or more different types of data, e.g., two or more of audio data, image data, text data, or graph data. As one example the multimodal data can include audio-visual data, comprising a combination of pixels of an image or of video and audio data representing values of a digitized audio waveform. As another example the multimodal data can include a combination of i) text data representing text in a natural language and ii) pixels of an image or of video or audio data representing values of an audio waveform.

Some examples of multimodal tasks include: open-vocabulary image classification (the output can classify the image input based on a text input comprising text descriptions of one or more classes in the image); open-vocabulary object detection (the output can detect one or more objects in the image input based on a text input comprising text descriptions of the one or more objects); image captioning (the output can comprise text that describes the image input); text-based image search (the output can identify from amongst multiple images in the image input one or more images that meet a text description of images to be retrieved, the text description being provided in a text input); image-based retrieval (the output can identify from amongst multiple images in the image input one or more images that match an further image in the image input), and so on. The multimodal processing tasks to be performed can be defined by text in the input sequences.

In some implementations the machine learning task can include an agent control task in which the agent interacts with an environment to perform the task. The agent can be a mechanical agent such a robot or (semi-)autonomous vehicle, interacting with a real-world environment to perform the task. The generative neural network 102 can be trained to control a simulated version of the agent in in a simulated version of the environment and then afterwards used to control the real agent in the real-world environment. The input sequence of tokens can include tokens that represent an observation of the environment, e.g., an image captured by a camera or other imaging device from a real-world environment. The output sequences of tokens comprises tokens that define one or more actions to be performed by the agent in the environment in response to the observation.

In some implementations the generative neural network 102 can be stored on a user computing device, i.e., a device local to the user, such as a mobile device, e.g., a mobile phone, or a smart speaker.

In some implementations the generative neural network 102 can be implemented on a remove server in communication with a user computing device over a wired or wireless network communications link between the user computing device and the server.

The user computing device can be provided with an input mechanism, such as a text or voice interface, that enables user input from the user in a natural language. The user computing device can be provided with an output mechanism that provides a system output for the user in the or another natural language, e.g., as speech or text; or in some other way, e.g., by displaying an image. The input and output mechanisms can include, e.g., a keyboard, microphone, speaker, display, and/or camera.

As an example, the input mechanism can include a system configured to input audio data characterizing a speech waveform of speech representing the input from the user in a natural language, and a system configured to convert the audio data into tokens representing the speech in the natural language, e.g., representing a transcription of the spoken input. The output mechanism can include a system configured to receive tokens representing the output for the user in the or another natural language and a system configured to convert the received tokens into audio data representing a waveform of speech representing the output to the user in the natural language, i.e., representing spoken words.

As a further example, the generative neural network 102 can be deployed in an environment that enables a user to provide a request for the system, e.g., to process a multimodal input to generate a corresponding output sequence output. Users can provide requests, e.g., by way of a user interface or through an application programming interface (API). The request can be transmitted from a user device, e.g., over a data communications network such as the internet, to one or more computers implementing the system, e.g., in a data center. The system can generate a output sequence and then transmit the output sequence to a user device over a data communications network.

A user computing device can be provided, as an interface for the generative neural network 102, with an input mechanism that enables user input from the user in a natural language and an output mechanism that provides a system output to the user in the natural language. The input and output mechanism can include, e.g., a keyboard and display. Also or instead the input and output mechanism can include a speech-based mechanism. For example, the input mechanism can include a system configured to input audio data characterizing a speech waveform of speech representing the input from the user in the natural language and configured to convert the audio data into tokens representing the speech in the natural language, e.g., representing a transcription of the spoken input. The output mechanism can include a system configured to receive tokens representing the output to the user in the natural language and a system configured to convert the received tokens into audio data representing a waveform of speech representing the output to the user in the natural language, i.e., representing spoken words.

In some implementations the input sequences include one or more natural language statements relating to an environment, in particular a real-world environment, and include natural language requests relating to the environment. Similarly the output sequences can include natural language replies or natural language output statements that also relate to the environment, i.e., providing information relating to the environment, in some implementations relating to or specifying actions to be taken in the environment.

The generative neural network 102 can be used for diagnosing faults, or for correcting undesired behavior, in a mechanical or computing system operating in the real world environment. The model inputs can include descriptions and/or images of observations of the mechanical or computing system, e.g., of operation of the system, optionally obtained from one or more sensors sensing a condition or operation of the system. An image observation can be converted into a text description, e.g., using an image captioning system or in other ways. The generated output sequences may include images, audio, or text that identify (describe) likely causes of the faults or undesired behavior. This can be used to repair the faults or correct the behavior. The preference measures for the machine learning task can define relatively more useful types of output for repairing faults or correcting behavior, and other aspects of the responses as previously described.

The generative neural network 102 can be used for controlling a mechanical agent such as a robot or vehicle. For example, the model inputs can include descriptions of tasks to be performed, and the generated output sequences can include lists of sub-tasks to be performed by the mechanical agent (trained to perform such sub-tasks), in order to perform the tasks. The preference measures for the machine learning task can define relatively more preferable or useful types of sub-task, task safety, efficiency, and so on.

As another example, the environment can be a computer security monitoring environment, e.g., the system can be deployed as part of a system that monitors the security of one or more computers. For example, the environment can be a computer network security monitoring environment, and the system can be deployed as part of a system that monitors the security of one or more computers on a computer network, e.g., a wireless network, a cellular network, a local area network and/or the internet. As another example, the environment can alternatively or additionally be a computer system security monitoring environment and the system can be deployed as part of a system that monitors the system for the presence of computer viruses and/or an unresolved software vulnerability, e.g., a zero-day exploit. A software vulnerability can be resolved by updating the software (e.g., patching) and/or removing (e.g., uninstalling) the software from the computer system. In these examples, the natural language requests can query whether computer security incidents have been resolved (e.g., “has the incident been resolved?”) and the model inputs can include relevant statements from system logs, i.e., that are potentially relevant to the events being queried. A computer security incident can be, e.g., a data breach, an unauthorized log-in or other access of a secured system, a detection of a computer virus or detection of a software vulnerability. An incident can be “resolved” when the underlying incident is no longer a threat to the security of the computer system e.g., the computer virus has been removed, the access to the secured system has been removed, the data breach has been mitigated, or the software having the vulnerability has been updated or removed. The system can use the model inputs to generate replies to the requests that include natural language statements indicating whether the incidents have been resolved, optionally displaying evidence used to determine this.

The model inputs can include one or more of: code snippets from the software code, system logs, program logs, or other artifacts that should be left on the computer by running the program, or verification rules that represent requirements for the execution of the software program, or natural language statements describing the computer system on which the software executes. In general, the model inputs can include relevant statements, i.e., statements that are potentially relevant to the events being queried.

In some implementations obtaining input data from the environment can include obtaining, from the system logs, the data characterizing the computer network, or both, or from other data as described above, one or more observations of the computer network (which here includes computers on the network), and processing the one or more observations to generate a natural language representation of the one or more observations. The natural language requests can relate to the computer security incidents or to the secure operation of the computer network. The machine learning task can include using the natural language representations of the one or more observations to provide one or more of the natural language statements describing the computer network, and using the natural language replies or the natural language output statements to identify a security status of the computer network or a security flaw in the computer network.

As another example, the environment can be a software testing or evaluation environment, e.g., the system can be deployed as part of a system that tests software before deployment or that evaluates already-deployed software to identify bugs. In these examples, when the system tests software before deployment, the natural language requests can ask whether the software will execute as intended, and the model inputs can include code snippets from the software code and, optionally, natural language statements describing the computer system on which the software will execute. The generative neural network 102 can process the model inputs to generate replies that indicate whether the code will execute as intended, optionally displaying evidence used to determine this. When the system monitors the execution of code after deployment, the natural language requests can ask whether a software program, or a portion of a software program, has executed as intended, and the model inputs can include one or more of: code snippets from the software code, system logs, program logs, or other artifacts that should be left on the computer by running the program, or verification rules that represent requirements for the execution of the software program, or natural language statements describing the computer system on which the software executes. The model 102 can then process the model inputs to generate replies that indicate whether the code has executed as intended, optionally displaying evidence used to determine this. As a particular example, the software program can be part of the boot up of a computer, and the model 102 can generate a reply each time that the computer starts up to verify whether the computer will function correctly after start up.

As another example, the environment can be an educational environment, e.g., the system can be deployed as part of an education software program that assists a user in learning or practicing one or more corresponding skills. In these examples, the model inputs can include natural language statements describing or referencing a scenario or scene in a real-world or imagined environment, and the requests can be questions about the scenario or scene.

As another example, the environment can be an information retrieval environment, e.g., the system can be deployed as part of a search engine or other software that allows a user to search for information in a corpus of documents, e.g., the Internet or another electronic document corpus. In these examples, the requests can be any appropriate natural language question, and the replies can optionally include evidence such as include relevant statements from the corpus of documents, e.g., as identified by searching the corpus using conventional information retrieval techniques.

In some implementations, the generative neural network 102 is a visual language model (VLM). In general, the VLM can process input sequences that include tokens that each represent natural language or (a part of) an image or video to generate output tokens that each represent natural language or (a part of) an image or video. For example, the VLM can be configured to describe an image or video using natural language, e.g., to perform an image or video captioning task. As another example, the VLM can be configured to process input tokens representing an image and text tokens representing a query about the image or a request to modifying the image, and to generate output tokens representing an answer to the query or representing a version of the image that has been modified in accordance with the request. The VLM can generate output tokens representing an image or video that is generated in response to input tokens providing a visual and/or audio and/or textual description of a desired image or video.

In some implementations, the “language” of the language model is not a natural language such (e.g., English), but can instead be a text-based encoding describing an entity or class of entities, e.g., a chemical or biological entity, such as a chemical structure or molecule. For example, the text-based encoding can be a sequence of tokens that defines a molecule or protein, e.g., a sequence specifying an arrangement of atoms or chemical functional groups in a molecule, or the amino acid residues of a protein. The language model can be referred to as a chemical and/or biological language model in such cases. The model inputs therefore be input strings defining chemical (e.g., protein) structures and the model outputs can include output strings defining different chemical structures from the input strings. The strings can be in the Simplified Molecular Input Line Entry System, SMILES, format, for example.

In another example of a computer language text generation task, a model input can include an image or video and a sequence of text in a computer language for performing a task in relation to the image or video, e.g., a data processing task that involves analyzing the content of the image or video to provide a result of the analysis or, e.g., a search to search for information relating to the content of the image or video. The computer language in the model output can include computer language for invoking a function or calling one or more external APIs. Merely as one example, such an output can be formatted as a JSON object. As previously, the sequence of text in a multimodal input can define the task to be performed and the second modality input can include, e.g., an image or video in relation to which the task is to be performed, e.g., a task that involves manipulation of particular types of data that may benefit from access to an API such as mathematical data, date/time related data, scientific data, recent data that may post-date training of the model (that can be accessed by a search function or API), and so on. After training, when the model is used in inference, the model output can include text in the or another computer language for performing a task, e.g., as described above, in relation to an image or video in the second modality input. The machine learning task can then include using the text in the computer language to perform the task.

In some implementations, the generative neural network 102 can be used to interact with a human user of a digital assistant such as a smart speaker, smart display, or other device. For example, information defining a task can be obtained from the digital assistant, and the digital assistant can be used to instruct the user to perform the task. For example, this can include receiving, at the digital assistant, a request from the user for assistance and determining, in response to the request, a series of tasks for the user to perform, e.g., steps or sub-tasks of an overall task. Then for one or more tasks of the series of tasks, e.g., for each task, e.g., until a final task of the series the digital assistant can be used to output to the user an indication of the task, e.g., step or sub-task, to be performed. This can be done using natural language, e.g., on a display and/or using a speech synthesis subsystem of the digital assistant. Visual, e.g., video, and/or audio observations of the user performing the task can be captured, e.g., using the digital assistant. A system can then be used to determine whether the user has successfully achieved the task, e.g., step or sub-task, i.e., from the answer as previously described. If there are further tasks to be completed the digital assistant can then, in response, progress to the next task (if any) of the series of tasks, e.g., by outputting an indication of the next task to be performed. In this way user can be led step-by-step through a series of tasks to perform an overall task.

As an illustrative example, a user can be interacting with a digital assistant and ask for help performing an overall task consisting of multiple steps, e.g., cooking a pasta dish. While the user performs the task, the digital assistant receives audio and/or video inputs representative of the user's progress on the task, e.g., images or video or sound clips of the user cooking. The digital assistant uses model 102 as described above, in particular by providing it with the captured audio and/or video and a question that asks whether the user has completed a particular step, e.g., ‘Has the user finished chopping the peppers?’, to determine whether the user has successfully completed the step. If the answer confirms that the user has successfully completed the step then the digital assistant progresses to telling the user to perform the next step or, if at the end of the task, or if the overall task is a single-step task, then the digital assistant may indicate this to the user. The digital assistant can then stop receiving or processing audio and/or video inputs to ensure privacy and/or reduce power use.

The digital assistant can also include a user interface to enable a user to request assistance and to output information. In implementations this is a natural language user interface and can include a keyboard, voice input-output subsystem, and/or a display. The digital assistant can further include an assistance subsystem configured to determine, in response to the request, a series of tasks for the user to perform. In implementations this can include a generative (large) language model, in particular for dialog. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g., of a series of tasks, e.g., until a final task of the series. More particularly, the assistance control subsystem and output to the user an indication of the task to be performed, capture, using the observation capture subsystem, visual or audio observations of the user performing the task, determine from the above-described answer whether the user has successfully achieved the task. In response, the digital assistant can progress to a next task of the series of tasks and/or control the digital assistant, e.g., to stop capturing observations.

In some implementations, a particular task that is to be performed by the generative neural network 102 can be described by part or all of a sequence of text in an input to the model 102. For example, in a model input that includes an image such a prompt can specify, e.g., “Generate a caption”, “Generate a description”, “Answer the following question: [about the image or video]”, or “Detect a person”. Where the model 102 is used for an agent control task a prompt can define, e.g., “Take the knife out of the drawer”, or “Q: What action should the robot take to take the knife out of the drawer?”. Also or instead such a prompt can give one or more examples of a task to be performed. The model 102 can be trained on multiple natural and/or computer languages and the prompt may then specify a language to use.

A few further examples of some machine learning tasks that can be performed by a generative neural network 102 trained as described herein follow. The tasks described below can include tasks that require spatial awareness or other context from input images or video. For example, a prompt may ask “What is the object in the top left corner?”.

In general, for the tasks below the model 102 can have been trained or fine-tuned on examples of the input and output for the task. For example, the model 102 can have been trained using still or moving images containing one or more objects or actions, and corresponding sequences of text or other data e.g., describing or classifying the images. However large, “foundation” models can, in general, perform some tasks zero-shot, i.e., without having been specifically trained on those tasks.

As one example the task can include an object or action detection task. For example, a generated output sequence can include or represent text that describes or otherwise labels detected object(s) or action(s) in an input that includes an image or audio, and can include coordinates such as bounding-box coordinates for the detected object(s) or action(s), e.g., “10 20 90 100 cat 20 30 100 100 dog”.

As another example the task can include a classification task, e.g., an object or action classification task. A generated output sequence can include data, e.g., text, that classifies the object(s) or action(s) in represented in conditioning data, e.g., in an image or audio, into one of a plurality of classes, or that otherwise classify object(s) or action(s) represented in the conditioning data.

As another example the task can include a still or moving image describing task, e.g., a captioning task (which, as used here, includes an audio description task to explain what is happening in an image). A generated output sequence can include data, e.g., text, describing an input image or video. For example, a generated output sequence can provide a caption or description or it can count objects in the image or video, or it can provide some other form of description.

As another example the task can include a still or moving image question-answering task. A generated output sequence can include data, e.g., text, that answers a question about an input, e.g., an input image or audio, where the question is also specified in the input, e.g., as sequence of text. This may be used, e.g., to answer questions about visual plots and charts or about sounds.

As another example the task can include a character or word recognition task, e.g., an OCR (optical character recognition) task. An input can include a still or moving image and a generated output sequence can include text that represents characters or words in the input, e.g., in a natural language.

As another example the task can include a still or moving image generation task. A generated output sequence can include image data defining values for pixels of a still or moving image, and an input, e.g., a sequence of text, may describe or characterize the image to be generated. Merely as an example, an image of a plot or chart can be generated to represent the input, e.g., comprising text.

As another example the task can include a computer language text generation task. An input can include a natural language description of a task to be performed, and optionally an image (if the task is to be performed on or in relation to an image), and a generated output sequence can include text in a computer language to perform the task, e.g., a task of analyzing the content of the image to provide a result of the analysis or to search for information relating to the content of the image.

As a particular example the computer language in a generated output sequence can include computer language for invoking a function or calling one or more external APIs. Merely as one example, such an output sequence can include data formatted as a JSON object. As previously, an input can define a task to be performed and can also include an image in relation to which the task is to be performed. In general the task can involves manipulation of particular types of data that can benefit from access to an API such as mathematical data, date/time related data, scientific data, recent data that may post-date training of the model 102 (that can be accessed by a search function or API), and so on; and the generated output sequence can include text in a computer language for performing the task. The machine learning task can include using the text in the computer language to perform the task.

In general where a generated output sequence includes text, such text can be converted to speech representing the text, and an audio (speech) output provided.

In some implementations the task can include an agent control task in which the agent interacts with an environment to perform the agent control task. In these implementations an input can include an observation characterizing the environment. For example, an input can include a sequence of text that defines a task to be performed by the agent and an image representing an observation of the environment, e.g., captured by a camera or other imaging device from a real-world environment. A generated output sequence can include an action selection output, e.g., including text, that is used to select one or more actions to be performed by the agent in the environment in response to the observation. As an illustration the generated output sequence can define an action as text such as “A: 132 114 128 5 25 156”, that can be converted into a control signal for a mechanical agent, such as a robot, e.g., “ΔT=[0.1, −0.2,0] ΔR=[10°, 25°, −7°]”. The action selection output can also or instead define one or more low-level skills, e.g., from a vocabulary of previously learnt skills. As before, a sequence of text in a model input can describe the task to be performed, e.g., “What action should the robot take to [perform task]”. Examples of systems for controlling an agent that can be fine tuned as described herein can include PaLM-E (Driess, et al., arXiv:2303.03378), RT-1 (Brohan, et al., arXiv:2212.06817), and RT-2 (Brohan, et al., arXiv:2307.15818).

In some agent control implementations, the environment is a real-world environment and the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent can be a robot or other mechanical agent interacting with the environment to accomplish a specific task, e.g., to locate or manipulate an object of interest in the environment or to move an object of interest to a specified location in the environment or to navigate to a specified destination in the environment. In these implementations, the observations can include, e.g., one or more of: images, object position data, and sensor data to capture observations as the agent interacts with the environment. The actions can define control signals to control the robot or other mechanical agent, e.g., positions, torques, or other control signals for the parts of the mechanical agent, or higher-level control commands.

In some agent control implementations the agent can be a human agent and the environment can be a real-world environment. For example, the agent can be a human user of a digital assistant such as a smart speaker, smart display, or some other device that is used to instruct the user to perform actions. The task can include any real-world task that the user wishes to perform. The observations can be obtained from an observation capture subsystem, e.g., a monitoring system such as a video camera or sound capture system, to capture visual observations of the user performing the task. The actions can include instructions in the form of, e.g., text, image, video, or audio data such as speech, that guide the user in performing the task.

The described systems and techniques can be applied to a wide range of different types of input sequences and output sequences. In implementations of the described techniques the tokens can represent, characterize, or encode any type of information in a sequence, e.g., stream of data. The term “represent” is used, below, generally to refer to any way in which a token can encode part of a sequence. The tokens may include marker tokens, such as a start of sequence token, an end of sequence token, and a separator token (indicating a separation or break between two distinct parts of a sequence). The tokens may, but need not be, drawn from a defined vocabulary of tokens.

Some of these implementations can be used for natural language tasks such as providing a natural language response to a natural language input, e.g., for question answering, or for text completion. In some implementations the input sequence can represent text in a natural language and the output sequence may represent text in the same natural language, e.g., a longer item of text. For example, in some implementations the input sequence can represent text in a natural language and the output sequence may represent the same text with a missing portion of the text added or filled in. For example, the output sequence can represent a predicted completion of text represented by the input sequence. Such an application can be used, e.g., to provide an auto-completion function, e.g., for natural language-based search. In some implementations the input sequence can represent a text in a natural language, e.g., posing a question or defining a topic, and the output sequence can represent a text in a natural language which is a response to the question or about the specified topic.

As another example the input sequence can represent a first item of text and the output sequence can represent a second, shorter item of text, e.g., the second item of text can be a summary of a passage that is the first item of text. As another example the input sequence can represent a first item of text and the output sequence can represent an aspect of the first item of text, e.g., it can represent an entailment task, a paraphrase task, a textual similarity task, a sentiment analysis task, a sentence completion task, a grammaticality task, and in general any natural language understanding task that operates on a sequence of text in some natural language, e.g., to generate an output that classifies or predicts some property of the text. For example, some implementations can be used to identify a natural language of the first item of text, or of spoken words where the input is audio (as described below).

Some implementations can be used to perform neural machine translation. Thus in some implementations the input tokens can represent words, wordpieces, or characters in a first natural language and the output tokens can represent words, wordpieces or characters in a second, different natural language. That is, the input sequence can represent input text in the first language and the output sequence can represent a translation of the input text into the second language.

Some implementations can be used for automatic code generation. For example, the input tokens can represent words, wordpieces or characters in a first natural language and the output tokens can represent instructions in a computer programming or markup language, or instructions for controlling an application program to perform a task, e.g., build a data item such as an image or web page.

Some implementations can be used for speech recognition. In such applications the input sequence can represent spoken words and the output sequence can represent a conversion of the spoken words to a machine-written representation, e.g., text. Then the input tokens can include tokens representing an audio data input including the spoken words, e.g., characterizing a waveform of the audio in the time domain or in the time-frequency domain. The output tokens can represent words, wordpieces, characters, or graphemes of a machine-written, e.g., text, representation of the spoken input, that is representing a transcription of the spoken input.

Some implementations can be used for handwriting recognition. In such applications the input sequence can represent handwritten words, syllabograms or characters and the output sequence may represent a conversion of the input sequence to a machine-written representation, e.g., text. Then the input tokens can include tokens representing portions of the handwriting and the output tokens can represent words, wordpieces, characters or graphemes of a machine-written, e.g., text, representation of the spoken input.

Some implementations can be used for text-to-speech conversion. In such applications the input sequence can represent text and the output sequence can represent a conversion of the text to spoken words. Then the input tokens can include tokens representing words or wordpieces or graphemes of the text and the output tokens can represent portions of audio data for generating speech corresponding to the text, e.g., tokens characterizing a portion of a waveform of the speech in the time domain or in the time-frequency domain, or phonemes.

Some implementations can be used for a genomics task, where the input sequence represents a fragment of a DNA sequence or other molecule sequence and the output sequence is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the model 102 can be configured to perform multiple different individual machine learning tasks, e.g., two or more of the machine learning tasks mentioned above. For example, the model 102 can be configured to perform multiple individual natural language understanding tasks, with the model inputs including an identifier for the individual natural language understanding task to be performed on the model inputs.

In some implementations the input sequence and the output sequence represent different modalities of input. For example, the input sequence can represent text in a natural language and the output sequence can represent an image or video corresponding to the text; or vice-versa. In general, the tokens can represent image or video features and a sequence of such tokens can represent an image or video. There are many ways to represent an image (or video) using tokens. As one example an image (or video) can be represented as a sequence of regions of interest (RoIs) in the image, optionally including one or more tokens for global image features. For example, an image can be encoded using a neural network to extract RoI features; optionally (but not essentially) a token can also include data, e.g., a position encoding, representing a position of the RoI in the image. As another example, the tokens can encode color or intensity values for pixels of an image. As another example, some image processing neural network systems, e.g., autoregressive systems, naturally represent images as sequences of image features. As another example, a transformer-based sequence processing neural network system as previously described can be used to process images instead of or as well as text (e.g., if trained on images instead of or as well as text).

Thus in some implementations at least one of the input sequence and the output sequence is a sequence representing an image or video and can include tokens representing the image or video. For example, the input sequence can be a sequence of text, the input tokens can represent words, wordpieces, or characters and the output sequence can include output tokens representing an image or video, e.g., described by the text, or providing a visual answer to a question posed by the text, or providing a visualization of a topic of the text. In another example the input sequence can include a sequence of input tokens representing an image or video, and the output tokens can represent words or wordpieces, or characters representing text, e.g., for a description or characterization of the image or video, or providing an answer to a question posed visually by the image or video, or providing information on a topic of a topic of the image or video.

In some other implementations both the input sequence and the output sequence can represent an image or video, and both the input tokens and the output tokens can represent a respective image or video. In such implementations the method/system can be configured to perform an image or video transformation. For example, the input sequence and the output sequence can represent the same image or video in different styles, e.g., one as an image the other as a sketch of the image; or different styles for the same item of clothing.

In some implementations the input sequence represents data to be compressed, e.g., image data, text data, audio data, or any other type of data; and the output sequence a compressed version of the data. The input and output tokens can each include any representation of the data to be compressed/compressed data, e.g., symbols or embeddings generated/decoded by a respective neural network.

In some implementations the input sequence represents a sequence of actions to be performed by an agent, e.g., a mechanical agent in a real-world environment implementing the actions to perform a mechanical task. The output sequence can include a modified sequence of actions, e.g., one in which an operating parameter, such as a speed of motion or power consumption, has a limited value; or one in which or safety or other boundary is less likely to be crossed. Then both the input tokens and the output tokens may represent the actions to be performed.

In some implementations the input sequence represents a sequence of health data and the output sequence can include a sequence of predicted treatment. Then the input tokens can represent any aspect of the health of a patient, e.g., data from blood and other medical tests on the patient and/or EHR (Electronic Health Record) data; and the output tokens can represent diagnostic information, e.g., relating to a disease status of the patient and/or relating to suggested treatments for the patient, and/or relating to a likelihood of an adverse health event for the patient.

As a particular example the model 102 can be a multimodal model neural network in which one or both of the model input (i.e., input sequence) and the model output (i.e., output sequence) include an image or audio. For example the multimodal machine learning model can be configured to process an input sequence including visual tokens representing pixels of a still or moving image (which here may include a point cloud image), and/or data representing an audio waveform, e.g., values or features of the audio waveform such as audio tokens, and/or text tokens representing a sequence of text, to generate an output sequence, e.g., including text tokens representing the still or moving image or audio waveform, and/or a sequence of intensity value inputs for the pixels of an image or a sequence of values defining an audio waveform. A visual token can, e.g., represent multiple pixels in a region of the image, e.g., as features of the region. Such a multimodal model 102 can perform any of the previously described tasks, e.g., using a multimodal input, or by providing a multimodal output, or by converting between different input and output modes (e.g., text/image/audio). For example, it can generate text representing, describing (e.g., captioning), or otherwise characterizing an image or audio input, e.g., by answering a question related to the image or audio input, e.g., relating to a future, e.g., physical prediction of a state of objects represented by the image or audio. As another example it can generate an image or audio represented, described, or otherwise characterized by a text input, or otherwise in response to the text input, e.g., representing an image or audio answer to a text question.

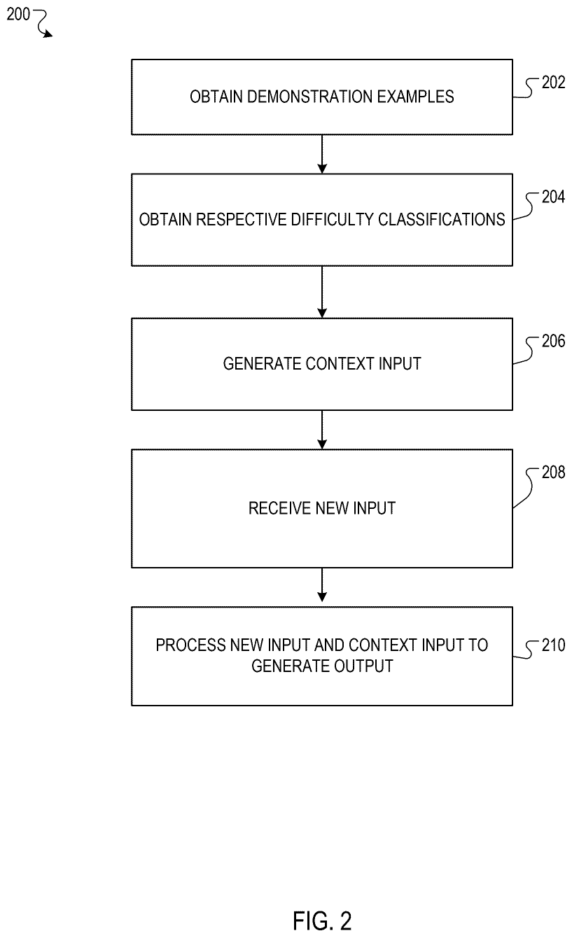

FIG. 2 is a flow diagram of an example process 200 for generating an output for a new input. For convenience, the process 200 will be described as being performed by a system of one or more computers located in one or more locations. For example, a training system, e.g., the neural network system 100 of FIG. 1, appropriately programmed in accordance with this specification, can perform the process 200.

The system obtains a plurality of demonstration examples for a task to be performed by a generative neural network (step 202). The plurality of demonstration examples each include a demonstration input and a demonstration output for the task. The demonstration input and demonstration output can be for any of the tasks described above. For example, the demonstration input can be a text input, i.e., include tokens representing text, and the demonstration output can be a text output. As another example, the demonstration input can be a text input and the demonstration output can include tokens representing one or more of audio, image, video, or other sensor data. As yet another example, the demonstration input can be a multi-modal input that includes tokens representing two or more different modalities and the demonstration example can include only tokens representing text or can also include tokens representing two or more different modalities.

As described above, in some implementations, the system retrieves the demonstration examples from a set of larger demonstration examples, e.g., based on similarity or relevance to the new input. In some other implementations, the system uses the same demonstration examples for all inputs for the task.

The system obtains a respective difficulty classification for each of the demonstration examples that classifies the demonstration example as either a difficult example for the task or as not a difficult example for the task (step 204).

For example, the system can receive the respective difficulty classifications as input. As another example, the system can generate the difficulty classifications. This is described in more detail below.

The system generates a context input that includes one or more instances of at least a subset of the demonstration examples (step 206).

As part of the generating, the system determines, for each of the demonstration examples, how many instances of the demonstration example to include in the context input based on the respective difficulty classification for the demonstration example.

In some implementations, each demonstration example includes a respective number of tokens and the context input has a maximum number of tokens. That is, the maximum number of tokens is the maximum size of the “context window” of the generative neural network and can be defined by, e.g., the maximum amount of memory or compute that is available for processing an input by the generative neural network. In these implementations, the system determines, for each of the demonstration examples, how many instances of the demonstration example to include in the context input subject to a constraint that a total number of tokens in the instances of the demonstration examples in the context input does not exceed the maximum number of tokens. For example, the system can generate a context input that maximizes the expected performance of the generative neural network without exceeding the maximum number of tokens.

Generally, the context input includes more instances of demonstration examples that are classified as difficult than instances of demonstration examples that are classified as not difficult. That is, the system determines to include more instances of demonstration examples that are classified as difficult than instances of demonstration examples that are classified as not difficult.

In some implementations, the system determines to include at least one instance of each demonstration examples. In some other implementations, the system determines to not include any instances, i.e., sets the determined number to zero, for one or more of the demonstration examples that are classified as not difficult.

The system then generates a context input that includes the determined number of each of the demonstration examples.

As a particular example, the system can generate a first sub-sequence that includes a respective instance of at least a subset of the demonstration examples and generate another sub-sequence that includes a respective additional instance of only each of the demonstration examples that have been classified as difficult. The system can then generate a context input that includes the first sub-sequence followed by the second sub-sequence. Thus, in this example, the additional instances are appended toward the end of the context input (and closer within the overall input to the new task input), effectively leveraging the context window of the generative neural network.

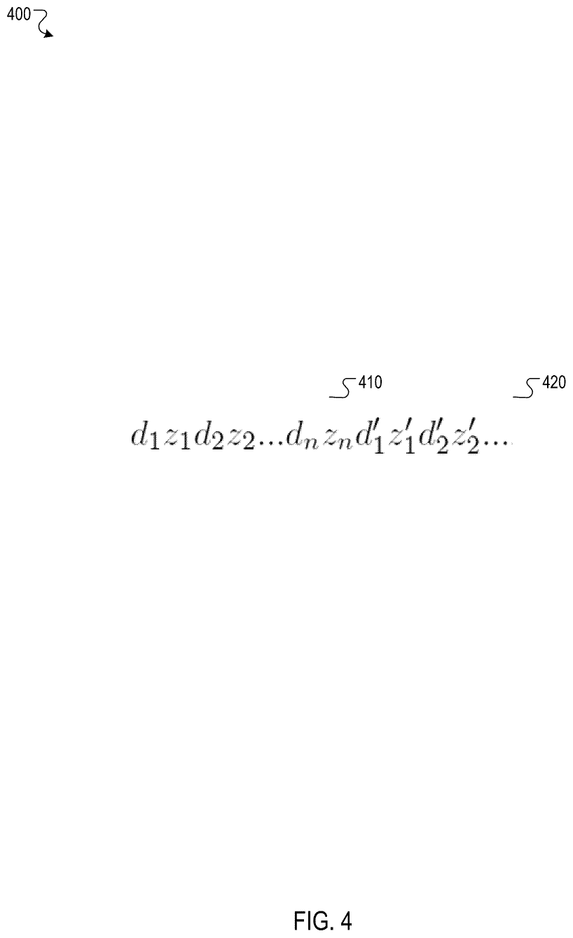

An example of generating the context input will be described in more detail below with reference to FIG. 4.

For example, the context input can include only the instances of the demonstration examples or can include the instances of the demonstration examples and additional data, e.g., a natural language instruction for performing the task, an explanation of the relevance of the instances of the demonstration examples, delimiting characters that separate the instances from one another, and so on.

The system receives the new input for the task (step 208).

The system processes an input that includes the context input and the new input using the first generative neural network to generate a new output (step 210). For example, the input can include the context input followed by the new input. Thus, the system uses the context input to provide the generative neural network with additional context about how to perform the task when generating a response to the new input. Because the context input includes more instances of difficult examples, the generative neural network can more effectively leverage information from the difficult examples when generating the output for the new input, improving the performance of the generative neural network, particularly when the new input would also have been difficult for the generative neural network without the additional context.

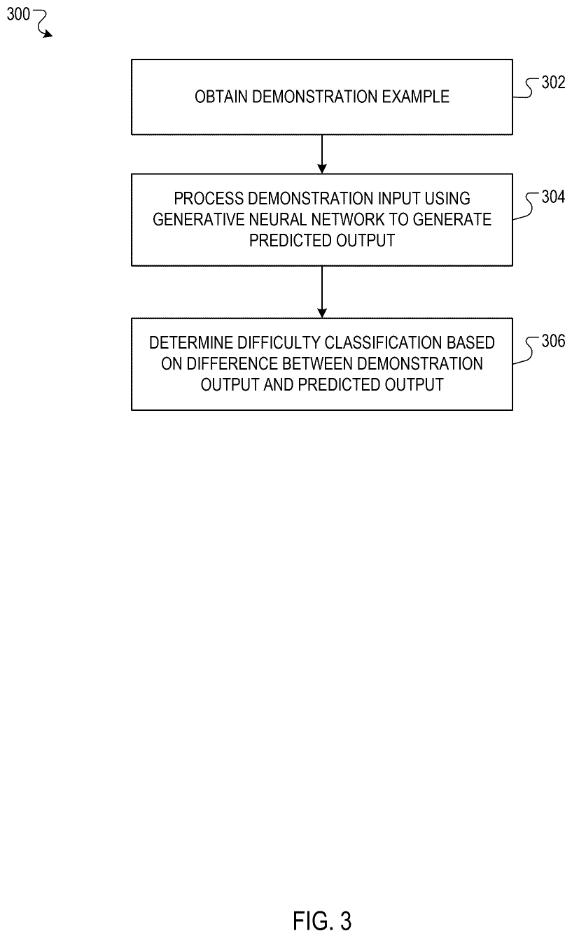

FIG. 3 is a flow diagram of an example process 300 for determining difficulty classifications. For convenience, the process 300 will be described as being performed by a system of one or more computers located in one or more locations. For example, a training system, e.g., the neural network system 100 of FIG. 1, appropriately programmed in accordance with this specification, can perform the process 300.

The system can perform the process 300 for each demonstration example in the set of demonstration examples to generate, for each demonstration example, a respective difficulty classification that classifies the demonstration example as either a difficult example for the task or as not a difficult example for the task.

The system receives a demonstration example that includes a demonstration input and a demonstration output (step 302).

The system processes an input that includes the demonstration input in the demonstration example using a second generative neural network to generate a predicted output (step 304).

For example, the second generative neural network can be the same as the generative neural network that will be used to perform the task, i.e., the generative neural network used in steps 208 and 210 above.

As another example, the second generative neural network can be a smaller generative neural network, i.e., can have fewer parameters than the generative neural network used in steps 208 and 210 above. For example, the second generative neural network can have fewer layers, fewer attention heads, or a smaller token dimension relative to the first generative neural network. In this example, using a smaller neural network can improve the computational efficiency of the “pre-processing” of the demonstration examples for generating the difficult classifications.

As a particular example, the input that includes the demonstration input can be a zero-shot input that does not include any other demonstration examples from the plurality of demonstration examples, e.g., that includes only the demonstration input or that includes only the demonstration input and a natural language prompt that instructs the generative neural network to perform the task.

The system then determines the difficulty classification for the demonstration example based on the difference between the demonstration output in the demonstration example and the predicted output (step 306).

For example, the system can classify the demonstration example as difficult when the demonstration output does not match the predicted output. As another example, the system can classify the demonstration example as not being difficult when the demonstration output does match the predicted output.

In some implementations, the system determines that the demonstration output matches the predicted output when the two outputs exactly match, i.e., each token in one output exactly matches a corresponding token in the other output, or by applying a different type of heuristic, e.g., based on edit distance.

In some other implementations, the system processes an input that includes the demonstration output and the predicted output using a language model neural network, e.g., the generative neural network or a different language model neural network, to generate an output that indicates whether the demonstration output is equivalent to the predicted output. That is, the system can use the language model neural network to determine whether the demonstration output matches the predicted output, e.g., in cases where whether two outputs match is otherwise ambiguous. As one example, two outputs that have the same semantic meaning can be identified as matching by the language model neural network even though they do not exactly match and have large edit distances.

FIG. 4 shows an example 400 of a context input. In the example 400, the set of demonstration examples D includes n demonstration examples {d₁, d₂, . . . , dₙ}. Additionally, the system has determined that a subset D′ of D that includes m demonstration examples {d₁′, d₂′, . . . , dₘ'} are difficult examples. Moreover, as part of generating the difficulty classifications, the system has generated a respective predicted output zᵢ for each demonstration example dᵢ, e.g., as described above.

Based on this, the system has generated the example context input 400. The example context input 400 includes a first sub-sequence 410 that includes a respective instance of each of the demonstration examples {d₁, d₂, . . . , dₙ}, i.e., includes both the difficult and not difficult examples. The sub-sequence 410 is followed by another sub-sequence 420 that includes a respective additional instance of only each of the demonstration examples {d₁′, d₂′, . . . , dₘ′} that have been classified as difficult. Thus, in this example, the additional instances are appended toward the end of the context input (and closer within the overall input to the new task input), effectively leveraging the context window of the generative neural network.

Moreover, in the example 400, the context input includes, for each instance of one or more of the demonstration examples, the predicted output zi generated for the demonstration example. By including the predicted outputs in the context input, i.e., whether or not the predicted outputs match the corresponding demonstration outputs, the system provides an error signal within the context input that signals to the generative neural network which demonstration examples are difficult and what the nature of the error was that was made for the demonstration examples. This gives the generative neural network additional context on how the demonstration examples should influence the output generated by the generative neural network for the new input.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a plurality of demonstration examples for a task to be performed by a first generative neural network, the plurality of demonstration examples each comprising a demonstration input and a demonstration output;
obtaining a respective difficulty classification for each of the demonstration examples that classifies the demonstration example as either a difficult example for the task or as not a difficult example for the task;
generating a context input that includes one or more instances of at least a subset of the demonstration examples, the generating comprising, for each of the demonstration examples, determining how many instances of the demonstration example to include in the context input based on the respective difficulty classification for the demonstration example;
receiving a new input for the task; and
processing an input that includes the context input and the new input using the first generative neural network to generate a new output.

2. The method of claim 1, wherein:
each demonstration example includes a respective number of tokens,
the context input has a maximum number of tokens, and
the generating comprises, for each of the demonstration examples, determining how many instances of the demonstration example to include in the context input subject to a constraint that a total number of tokens in the instances of the demonstration examples in the context input not exceed the maximum number of tokens.

3. The method of claim 1, wherein obtaining a respective difficulty classification for each of the demonstration examples comprises:
processing an input comprising the demonstration input in the demonstration example using a second generative neural network to generate a predicted output; and
determining the difficulty classification for the demonstration example based on a difference between the demonstration output in the demonstration example and the predicted output.

4. The method of claim 3, wherein determining the difficulty classification for the demonstration example based on a difference between the demonstration output in the demonstration example and the predicted output comprises:
classifying the demonstration example as difficult when the demonstration output does not match the predicted output.

5. The method of claim 3, wherein determining the difficulty classification for the demonstration example based on a difference between the demonstration output in the demonstration example and the predicted output comprises:
processing an input comprising the demonstration output and the predicted output using a third language model neural network to generate an output that indicates whether the demonstration output is equivalent to the predicted output, and
classifying the demonstration example as difficult when the demonstration output is equivalent to the predicted output.

6. The method of claim 3, wherein the second generative neural network is the same neural network as the first generative neural network.

7. The method of claim 3, wherein the second generative neural network has fewer parameters than the first generative neural network.

8. The method of claim 3, wherein the input that comprises the demonstration input is a zero-shot input that does not include any other demonstration examples from the plurality of demonstration examples.

9. The method of claim 3, wherein the context input includes, for each instance of one or more of the demonstration examples, the predicted output generated for the demonstration example.

10. The method of claim 1, wherein the context input includes more instances of demonstration examples that are classified as difficult than instances of demonstration examples that are classified as not difficult.

11. The method of claim 1, wherein obtaining the demonstration examples comprises:
performing a search to identify the demonstration examples from a repository of demonstration examples.

12. The method of claim 1, wherein generating a context input that includes one or more instances of at least a subset of the demonstration example comprises:
generating a first sub-sequence that includes a respective instance of at least a subset of the demonstration examples;
generating a second sub-sequence that includes a respective additional instance of only each of the demonstration examples that have been classified as difficult; and
generating a context input that includes the first sub-sequence followed by the second sub-sequence.

13. The method of claim 1, wherein the neural network is not trained on any of the demonstration examples after obtaining the demonstration examples and prior to receiving the new input.

14. The method of claim 1, wherein the neural network is a generative neural network that generates an output token sequence from an input token sequence including the context input and the new input, and wherein the generative neural network is configured to process the input token sequence to generate for each position in the output token sequence, a respective score for each token in a vocabulary of output tokens.

15. The method of claim 1, wherein the new output comprises a language and/or image and/or audio response to the prompt.

16. The method of claim 1, wherein the input comprises an input image and wherein the new output is classification data item that identifies a label for an object class to which the input belongs, and wherein the object class corresponds to a class of object depicted in the input image.

17. A system comprising:
one or more computers; and
one or more storage devices communicatively coupled to the one or more computers, wherein the one or more storage devices store instructions that, when executed by the one or more computers, cause the one or more computers to perform operations comprising:
obtaining a plurality of demonstration examples for a task to be performed by a first generative neural network, the plurality of demonstration examples each comprising a demonstration input and a demonstration output;
obtaining a respective difficulty classification for each of the demonstration examples that classifies the demonstration example as either a difficult example for the task or as not a difficult example for the task;
generating a context input that includes one or more instances of at least a subset of the demonstration examples, the generating comprising, for each of the demonstration examples, determining how many instances of the demonstration example to include in the context input based on the respective difficulty classification for the demonstration example;
receiving a new input for the task; and
processing an input that includes the context input and the new input using the first generative neural network to generate a new output.

18. The system of claim 17, wherein generating a context input that includes one or more instances of at least a subset of the demonstration example comprises:
generating a first sub-sequence that includes a respective instance of at least a subset of the demonstration examples;
generating a second sub-sequence that includes a respective additional instance of only each of the demonstration examples that have been classified as difficult; and
generating a context input that includes the first sub-sequence followed by the second sub-sequence.

19. The system of claim 17, wherein the neural network is not trained on any of the demonstration examples after obtaining the demonstration examples and prior to receiving the new input.

20. One or more non-transitory computer storage media storing instructions that when executed by one or more computers cause the one or more computers to perform operations comprising:
obtaining a plurality of demonstration examples for a task to be performed by a first generative neural network, the plurality of demonstration examples each comprising a demonstration input and a demonstration output;
obtaining a respective difficulty classification for each of the demonstration examples that classifies the demonstration example as either a difficult example for the task or as not a difficult example for the task;
generating a context input that includes one or more instances of at least a subset of the demonstration examples, the generating comprising, for each of the demonstration examples, determining how many instances of the demonstration example to include in the context input based on the respective difficulty classification for the demonstration example;
receiving a new input for the task; and
processing an input that includes the context input and the new input using the first generative neural network to generate a new output.
